(19) United States
(12) Patent Application Publication
(10) Pub. No.: US 2009/0212246 A1
(43) Pub. Date: Aug. 27, 2009

(54) VALVE GASKET

(76) Inventors: Brent J. Bower, Whitehall, MI (US); Kenneth J. Parker, Lake Orion, MI (US); Michael R. Smith, Comstock Park, MI (US); Daniel G. Stanhope, Muskegon, MI (US)

Correspondence Address: PATENT GROUP 2N;JONES DAY, NORTH POINT, 901 LAKESIDE AVENUE, CLEVELAND, OH, 44114, US

(21) Appl. No.: 12/237,682

(22) Filed: Sep. 25, 2008

Related U.S. Application Data
(60) Provisional application No. 61/030,251, filed on Feb. 21, 2008.

(51) Int. Cl. F16K 31/02; F16K 1/48

(52) U.S. Cl. 251/129.15; 251/357

(57) ABSTRACT

A gasket fits between a deck plate and a solenoid valve in a lifter oil manifold assembly. The valve has a planar end surface with valve ports. The gasket has gasket ports for alignment with the valve ports. The gasket further has a planar sealing surface. The planar sealing surface on the gasket surrounds the gasket ports, and abuts the end surface of the solenoid valve fully around the valve ports. The gasket preferably includes a rib structure that extends lengthwise to surround the array of gasket ports. The rib structure is deflectable to the plane of the sealing surface under a clamping force applied to the gasket by the deck plate and the end surface of the valve.

### RELATED APPLICATIONS

This application claims the benefit of provisional U.S. Patent Application 61/030,251, filed Feb. 21, 2008, which is incorporated by reference in its entirety.

### TECHNICAL FIELD

This technology relates to a lifter oil manifold assembly for an internal combustion engine.

### BACKGROUND

An internal combustion engine may have lifters that function to shift certain cylinders into and out of operation. The lifters are actuated by hydraulic fluid pressure. The pressure is applied to the lifters by oil in a lifter oil manifold assembly. The lifter oil manifold assembly includes solenoid valves to control the oil pressure. The valves are mounted on a deck plate, and a gasket may also be mounted on the deck plate to provide a hydraulic fluid seal.

### SUMMARY

A gasket fits between a deck plate and a solenoid valve in a lifter oil manifold assembly. The valve has a planar end surface with valve ports. The gasket has gasket ports for alignment with the valve ports. The gasket further has a planar sealing surface. The planar sealing surface on the gasket surrounds the gasket ports, and abuts the end surface of the solenoid valve fully around the valve ports.

The gasket preferably includes a rib structure that extends lengthwise to surround the array of gasket ports. The rib structure is deflectable to the plane of the sealing surface under a clamping force applied to the gasket by the deck plate and the end surface of the valve.

### BRIEF DESCRIPTION OF THE DRAWINGS

FIG. 1 is an exploded view of parts of a lifter oil manifold assembly.

FIG. 2 is a view of the same parts shown in FIG. 1, but viewed from beneath.

FIG. 3 is an enlarged view of a part shown in FIG. 1.

FIG. 4 is an exploded view showing distinct sections of another part shown in FIG. 1.

FIG. 5 is a view similar to FIG. 4, as viewed from beneath.

FIG. 6 is an enlarged partial view of parts shown in FIG. 1.

FIG. 7 is an enlarged sectional view of a portion of a part shown in FIG. 6.

### DETAILED DESCRIPTION

The apparatus shown in the drawings has parts that are examples of the elements recited in the claims. The following description thus includes examples of how a person of ordinary skill in the art can make and use the claimed invention. It is presented here to meet the statutory requirements of written description, enablement, and best mode without imposing limitations that are not recited in the claims.

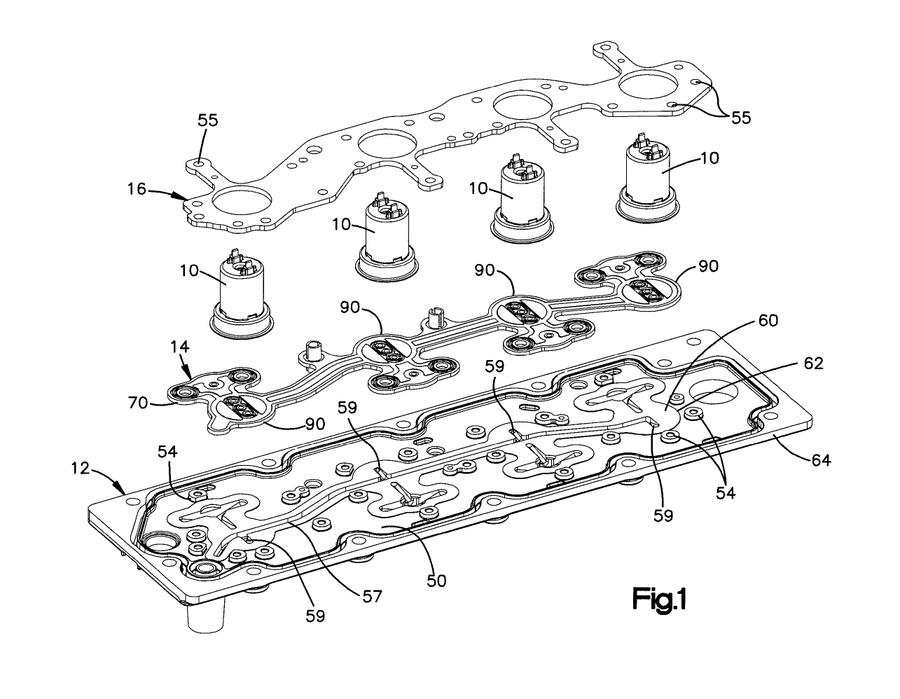

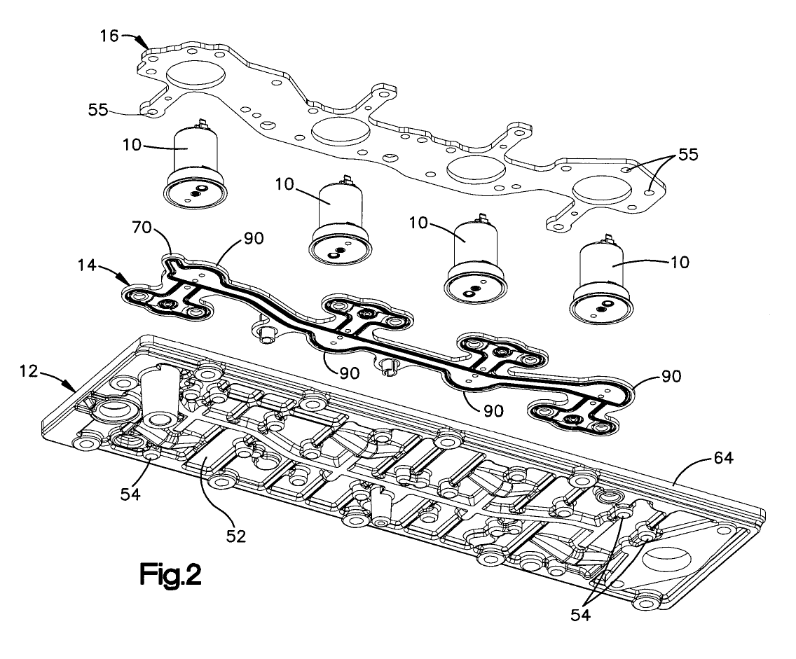

FIGS. 1 and 2 show parts of a lifter oil manifold assembly. These parts include four solenoid valves 10 and a deck plate 12 upon which the valves 10 are mounted. A gasket 14 fits between the valves 10 and the deck plate 12. A retainer plate 16 fits over the valves 10, and is fastened to the deck plate 12 to retain the valves 10 in place. When the valves 10 are retained on the deck plate 12 in this manner, the gasket 14 is compressibly engaged between the valves 10 and the deck plate 12 to provide a fluid seal.

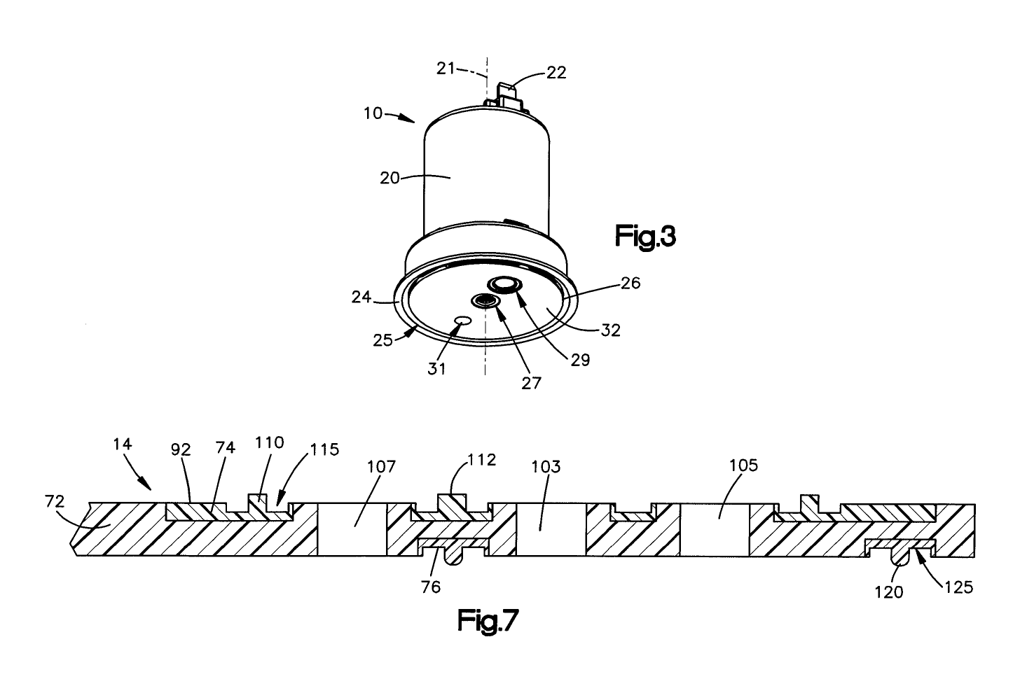

The valves 10 in the illustrated example are alike. Each has a cylindrical housing 20 with a longitudinal central axis 21 (FIG. 3). Electrical terminal blades 22 project from one end of the housing 20. An annular flange 24 defines a circular opening 25 at the opposite end of the housing 20. A disk-shaped port device 26 is received closely within the housing 20 to close the opening 25.

A first fluid supply port 27 extends through the port device 26 along the axis 21. A second fluid supply port 29 extends through the port device 26 at a location spaced radially from the first supply port 27, and a fluid control port 31 extends through the port device 26 at a location radially opposite the second supply port 29. The circular end surface 32 of the port device 26 surrounds the ports 27, 29 and 31 and lies in a plane perpendicular to the axis 21. The end surface 32 is spaced a short distance axially outward from the surrounding flange 24 to define the terminal end surface of the valve 10 at that end of the housing 20.

The deck plate 12 is a cast metal part with a one side 50 shown in FIG. 1 and the opposite side 52 shown in FIG. 2. Mounting bosses 54 on the deck plate 12 define bores for receiving fasteners, and are arranged throughout the length and width of the deck plate 12 for alignment with corresponding fastener openings 55 in the retainer plate 16. Fluid flow channels are also located on the deck plate 12. The channels and are open at the side 50 that is shown in FIG. 1, and include an elongated primary supply channel 57 and four secondary supply channels 59. The secondary supply channels 59 branch outward from the primary supply channel 57 at locations that are spaced apart along the length of the primary supply channel 57. More specifically, the secondary supply channels 59 are arranged in pairs on opposite sides of the primary supply channel 57, and extend laterally from the primary supply channel 57 at four locations corresponding to the locations at which the four valves 10 are mounted on the deck plate 12. The supply channels 57 and 59 are all surrounded by a planar deck surface 60. The deck surface 60 has a peripheral edge 62 that is entirely distinct and spaced inward from the peripheral edge 64 of the deck plate 12 so that the entire deck surface 60 itself is spaced inward from the periphery of the deck plate 12.

The gasket 14 in the illustrated example has a peripheral edge 70 with the same length and contour as the peripheral edge 62 of the deck surface 60. This provides the gasket 14 with the same size and shape as the deck surface 60. The gasket 14 is thus configured to coextensively overlay the deck surface 60 when the gasket 14 is interposed between the valves 10 and the deck plate 12.

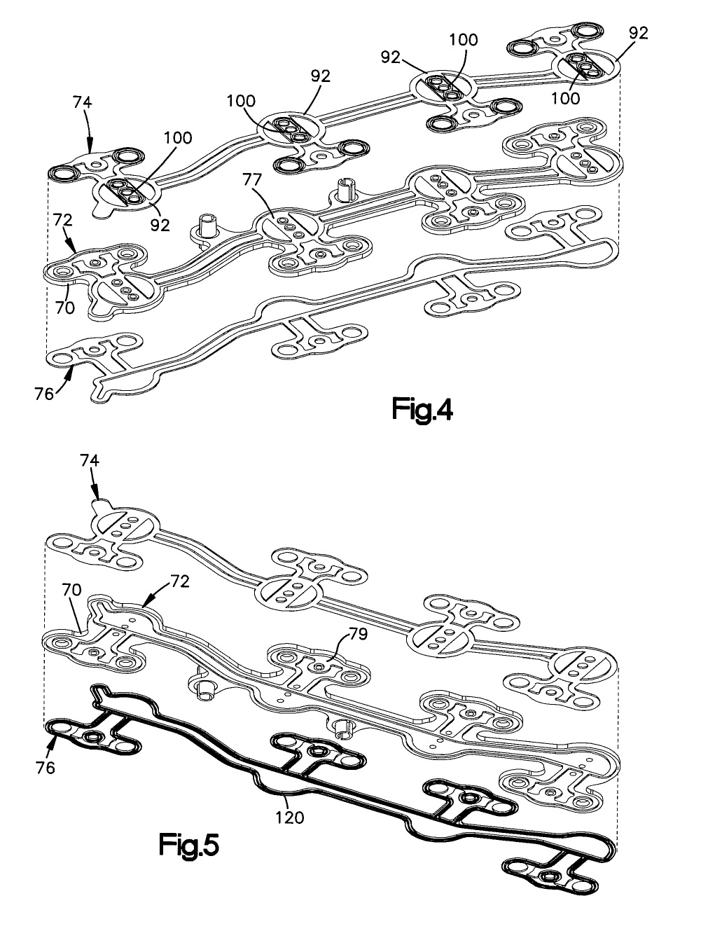

Although this example of a gasket 14 is a unitary structure as shown in FIGS. 1 and 2, it preferably has three distinct parts that are shown separately in FIGS. 4 and 5. These include a carrier part 72 and a pair of inserts 74 and 76. The inserts 74 and 76 are located on opposite sides of the carrier part 72, and may be referred to as the upper insert 74 and the lower insert 76.

The carrier part 72 of the gasket 14 is formed of a relatively rigid plastic material. The upper and lower inserts 74 and 76 are formed of more flexible plastic material to provide seal beads on opposite sides of the carrier part 72. Recesses 77 and 79 at the opposite sides of the carrier part 72 correspond to the configurations of the upper and lower inserts 74 and 76, respectively, so that the gasket 14 can be formed by placing the carrier part 72 in a mold cavity, and by injecting the molten plastic material of the inserts 74 and 76 into the recesses 77 and 79.

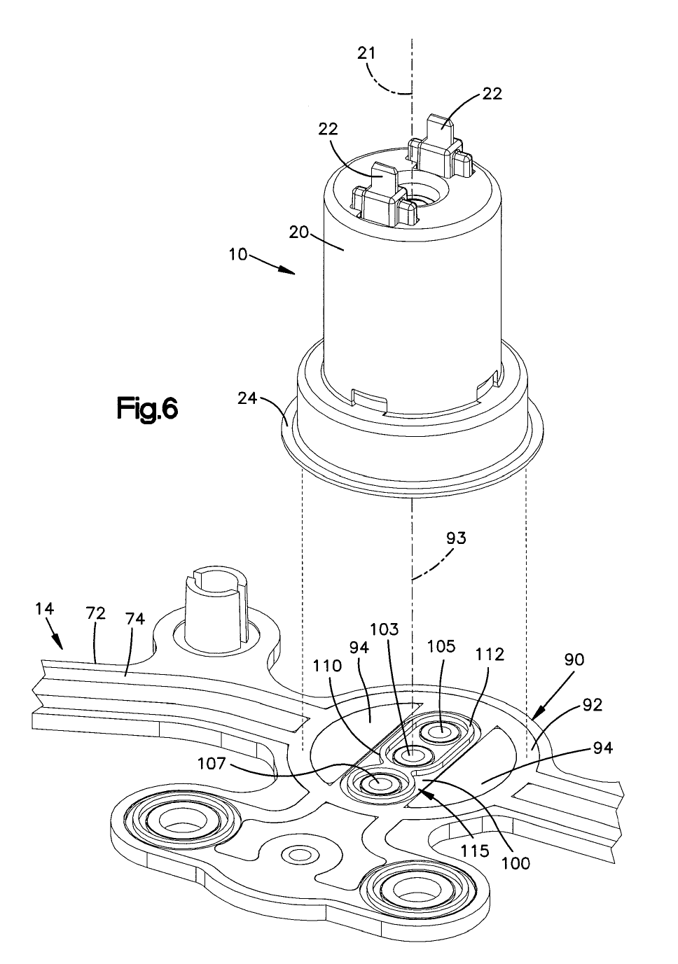

The carrier part 72 has the peripheral edge 70 that defines the peripheral size and shape of the gasket 14 as a whole. That shape has four circular regions 90, each of which is configured to receive a valve 10. As shown for example in FIG. 6, the upper insert 74 has a ring-shaped surface 92 centered on the axis 93 of each circular region 90. The outer diameter of the ring-shaped surface 92 is not less than, and is preferably slightly greater than, the diameter of the circular end surface 32 of a valve 10. The carrier part 72 of the gasket 14 has a symmetrical pair of surfaces 94 that are shaped as circular segments within the circular region 90. The segmentally shaped surfaces 94 are concentric and co-planar with the surrounding ring-shaped surface 92.

In addition to the ring-shaped surfaces 92, the upper insert 74 also defines a central part 100 of each circular region 90 of the gasket 14. The central part 100 extends diametrically within the surrounding ring-shaped surface 92, and fills the gap between the two segmentally shaped surfaces 94. Three ports extend through the gasket 14 at the central part 100. A first fluid supply port 103 is centered on the axis 93. A second fluid supply port 105 is spaced radially from the first supply port 103, and a fluid control port 107 is located radially opposite the second supply port 105.

As further shown in FIG. 6, the upper insert 74 defines a deflectable rib structure 110. In the illustrated example, the rib structure 110 surrounds all three ports 103, 105 and 107, but surrounds the control port 107 separately from the supply ports 103 and 105 to isolate the control port 107 from the supply ports 103 and 105. When the rib structure 110 is in the original, undeflected condition shown in the drawings, it has a uniform height with a planar top surface 112 spaced axially upward from the ring-shaped surface 92. The upper insert 74 also defines a trough 115 in which the rib structure 110 is located. The trough 115 is recessed from the ring-shaped surface 92 to provide space on laterally opposite sides of the rib structure 110 along the entire length of the rib structure 110. As best shown in FIG. 7, the lower insert 76 has a similar rib structure 120 projecting outward from a trough 125.

When a valve 10 is placed on the gasket 14, it is placed coaxially over a circular region 90 of the gasket 14 as indicated in FIG. 6. The valve ports 27, 29 and 31 are aligned with the gasket ports 103, 105 and 107. The valve 10 first rests on the rib structure 110, with the end surface 32 of the valve 10 overlying the top surface 112 of the rib structure 110. When the retainer plate 16 is received over the valve 10, it presses the flange 24 downward under a clamping force developed by fasteners that are tightened between the retainer plate 16 and the deck plate 12. The clamping force is applied to the gasket 14 by the overlying surface 32 of the valve 10 and the underlying surface 60 of the deck plate 12. This causes the rib structure 110 at the upper insert 74 to deflect compressively beneath the valve surface 32 until the valve surface 32 moves into abutment with the ring-shaped surface 92. The trough 115 provides lateral clearance for the axially compressive deflection of the rib structure 110. As a result, the fluid seal provided by the axial force of engagement between the gasket 14 and the valve 10 is enhanced by the rib structure 110.

The patentable scope of the invention is defined by the claims, and may include other examples of how the invention can be made and used. Such other examples, which may be available either before or after the application filing date, are intended to be within the scope of the claims if they have elements that do not differ from the literal language of the claims, or if they have equivalent elements with insubstantial differences from the literal language of the claims.

What is claimed is:

1. An apparatus for use in a lifter oil manifold assembly including a deck plate having a planar surface with open fluid flow channels and solenoid valve having a planar end surface surrounding an array of valve ports, the apparatus comprising:
a gasket configured to fit between the planar surface of the deck plate and the planar end surface of the solenoid valve, the gasket having an array of gasket ports configured for alignment with the array of valve ports, and further having a planar sealing surface that surrounds the array of gasket ports and is configured to abut the planar end surface of the valve fully around the array of valve ports.

2. An apparatus as defined in claim 1 wherein the gasket includes a rib structure that extends lengthwise to surround the array of gasket ports, has height projecting from the plane of the sealing surface, and is deflectable to the plane of the sealing surface under a clamping force applied to the gasket by the planar surface of the deck plate and the planar end surface of the valve.

3. An apparatus as defined in claim 2 wherein the rib structure is continuous around the entire array of gasket ports.

4. An apparatus as defined in claim 2 wherein the rib structure surrounds one of the gasket ports to isolate that port from others in the array of gasket ports.

5. An apparatus as defined in claim 2 wherein the gasket is configured with clearance for the rib structure to deflect to the plane of the sealing surface.

6. An apparatus as defined in claim 5 wherein the gasket has a trough that traverses the rib structure to provide the clearance.

7. An apparatus as defined in claim 1 wherein the gasket ports include a supply port, a control port, and a purge port.

8. An apparatus comprising:
a deck plate having a planar surface with open fluid flow channels;
a solenoid valve having a planar end surface surrounding an array of valve ports; and
a gasket configured to fit between the planar surface of the deck plate and the planar end surface of the solenoid valve, the gasket having an array of gasket ports configured for alignment with the array of valve ports, and further having a planar sealing surface that surrounds the array of gasket ports and is configured to abut the planar end surface of the valve fully around the array of valve ports.

9. An apparatus as defined in claim 8 wherein the gasket and the planar surface of the deck plate have the same peripheral size and shape.

10. An apparatus as defined in claim 8 wherein the planar deck surface has a peripheral edge that is entirely distinct and spaced inward from the peripheral edge of the deck plate.

11. An apparatus as defined in claim 8 wherein the gasket includes a rib structure that extends lengthwise to surround the array of gasket ports, has height projecting from the plane of the sealing surface, and is deflectable to the plane of the sealing surface under a clamping force applied to the gasket by the planar surface of the deck plate and the planar end surface of the valve.

12. An apparatus as defined in claim 11 wherein the rib structure is continuous around the entire array of gasket ports.

13. An apparatus as defined in claim 11 wherein the rib structure surrounds one of the gasket ports to isolate that port from others in the array of gasket ports.

14. An apparatus as defined in claim 11 wherein the gasket is configured with clearance for the rib structure to deflect to the plane of the sealing surface.

15. An apparatus as defined in claim 14 wherein the gasket has a trough that traverses the rib structure to provide the clearance.

16. An apparatus as defined in claim 8 wherein the gasket ports include a supply port, a control port, and a purge port.
